(19) United States
(12) Patent Application Publication
(10) Pub. No.: US 2025/0379343 A1
(43) Pub. Date: Dec. 11, 2025

(54) HIGH-SIDE BATTERY CELL PROTECTION

(71) Applicant: Cirrus Logic International Semiconductor Ltd., Edinburgh (GB)

(72) Inventors: Prashanth DRAKSHAPALLI, Austin, TX (US); Luke LAPOINTE, Austin, TX (US); Anindya BHATTACHARYA, Austin, TX (US)

(73) Assignee: Cirrus Logic International Semiconductor Ltd., Edinburgh (GB)

(21) Appl. No.: 18/905,217

(22) Filed: Oct. 3, 2024

Related U.S. Application Data
(60) Provisional application No. 63/657,012, filed on Jun. 6, 2024.

(51) Int. Cl. H01M 50/574; H01M 10/42; H01M 10/48

(52) U.S. Cl. CPC H01M 50/574; H01M 10/425; H01M 10/48; H01M 2010/4271

(57) ABSTRACT

A system may include a battery, a protection field-effect transistor electrically coupled to a first terminal of the battery, such that when the protection field-effect transistor is deactivated, substantially zero electrical current flows to and from the battery, and a battery management system electrically coupled to the protection field-effect transistor and configured to sense a first voltage across the protection field-effect transistor and control the protection field-effect transistor based on the first voltage.

### RELATED APPLICATION

The present disclosure claims priority to U.S. Provisional Patent Application Ser. No. 63/657,012, filed Jun. 6, 2024, which is incorporated by reference herein in its entirety.

### FIELD OF DISCLOSURE

The present disclosure relates in general to circuits for electronic devices, including without limitation personal audio devices such as wireless telephones and media players, and more specifically, a battery management system providing protection for a high-side of a battery cell.

### BACKGROUND

Portable electronic devices, including wireless telephones, such as mobile/cellular telephones, tablets, cordless telephones, mp3 players, smart watches, health monitors, and other consumer devices, are in widespread use. Such a portable electronic device may include a battery (e.g., a lithium-ion battery) for powering components of the portable electronic device. Typically, such batteries used in portable electronic devices are rechargeable, such that when charging, the battery converts electrical energy into chemical energy which may later be converted back into electrical energy for powering components of the portable electronic device.

Such devices may include a battery management system, which may be implemented as a battery management integrated circuit (IC), for fuel gauging of a battery. A battery management system may include functionality to detect fault conditions in order to protect one or more cells of the battery. Being able to accurately sense such fault conditions is important so that a protection field-effect transistor (FET) is activated or deactivated at the appropriate or correct times. An external sense resistor, such as a precision high-side resistor, may be utilized to sense current through the protection FET(s) to define thresholds for the different faults that can happen. However, such a high side external sense resistor can undesirably consume significant power.

Thus, it is desired to eliminate the use of a high-side external sense resistor for a battery management IC, and it is also desired to more accurately determine the thresholds for activating or deactivating the protection FET(s) based on a particular type of detected fault condition.

### SUMMARY

In accordance with the teachings of the present disclosure, one or more disadvantages and problems associated with existing approaches to battery cell protection may be reduced or eliminated.

In accordance with embodiments of the present disclosure, a system may include a battery, a protection field-effect transistor electrically coupled to a first terminal of the battery, such that when the protection field-effect transistor is deactivated, substantially zero electrical current flows to and from the battery, and a battery management system electrically coupled to the protection field-effect transistor and configured to sense a first voltage across the protection field-effect transistor and control the protection field-effect transistor based on the first voltage.

In accordance with these and other embodiments of the present disclosure, a method may include sensing a first voltage across a protection field-effect transistor electrically coupled to a first terminal of a battery and controlling the protection field-effect transistor based on the first voltage, such that when the protection field-effect transistor is deactivated, substantially zero electrical current flows to and from the battery.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates an example system for charging a battery, in accordance with embodiments of the present disclosure; and

FIG. 2 illustrates selected components of a battery management system, in accordance with embodiments of the present disclosure.

### DETAILED DESCRIPTION

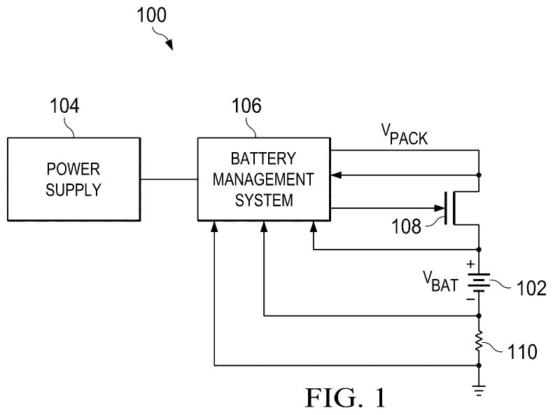

FIG. 1 illustrates an example system 100 for charging a battery 102, in accordance with embodiments of the present disclosure. As shown in FIG. 1, system 100 may include battery 102, a power supply 104, a battery management system 106, a protection FET 108, and a low-side sense resistor 110.

Battery 102 may include any system, device, or apparatus configured to convert chemical energy stored within battery 102 to electrical energy. For example, in some embodiments, battery 102 may be integral to a portable electronic device, and battery 102 may be configured to deliver electrical energy to components of such portable electronic device. Further, battery 102 may also be configured to recharge, in which it may convert electrical energy received by battery 102 into chemical energy to be stored for later conversion back into electrical energy. As an example, in some embodiments, battery 102 may comprise a lithium-ion battery.

Power supply 104 may include any system, device, or apparatus configured to supply electrical energy to battery management system 106. In some embodiments, power supply 104 may include a direct-current (DC) power source configured to deliver electrical energy at a substantially constant voltage. Accordingly, a peak-to-average power delivered from power supply 104 may be approximately equal to 1. In some of such embodiments, power supply 104 may include an alternating current (AC)-to-DC converter/adapter, configured to convert an AC voltage (e.g., provided by an electrical socket installed in the wall of a building) into a DC voltage. In some embodiments, power supply 104 may be power limited in terms of a maximum amount of power that may be drawn from power supply 104.

Battery management system 106 may include any system, device, or apparatus configured to receive electrical energy from power supply 104 and/or battery 102, and control delivery of such energy to and/or from battery 102, such that battery 102 may be charged using pulsed current charging, in a manner in which a peak-to-average power delivered from battery management system 106 to battery 102 may be significantly greater than 1 (e.g., 2 or more). In some embodiments, battery management system 106 May comprise a battery charger, configured to deliver electrical energy to battery 102 in order that battery 102 converts the electrical energy to chemical energy that is stored in battery 102. In some embodiments, battery management system 106 may include a wired charger configured to draw electrical energy from an electrical power outlet or from a power bank. In other embodiments, battery management system 106 may include a wireless charger configured to draw electrical energy via inductive coupling from a wireless charging pad or similar device.

Protection FET 108 may include any suitable transistor which may be activated (e.g., turned on, closed, enabled, etc.), deactivated (e.g., turned off, opened, disabled, etc.), and regulated (e.g., to operate in a constant control mode, etc.) in response to a control signal from battery management system 106. Although FIG. 1 depicts only a single protection FET 108 for the purposes of clarity and exposition, it is understood that system 100 may include any suitable number of protection FETs 108.

Low-side sense resistor 110 may comprise any suitable system, device, or apparatus for which a voltage across low-side sense resistor 110 is substantially proportional to a current flowing through low-side sense resistor 110, in accordance with Ohm's Law.

In operation, with protection FET 108 activated, battery management system 106 may monitor operating parameters associated with battery 102, including without limitation a current sensed through either or both of protection FET 108 and/or sense resistor 110, voltages associated with battery 102, and/or other parameters, to determine if battery 102 is in a fault state. If a fault state exists, battery management system 106 may protect battery 102 by deactivating protection FET 108, such that current ceases flowing from battery 102.

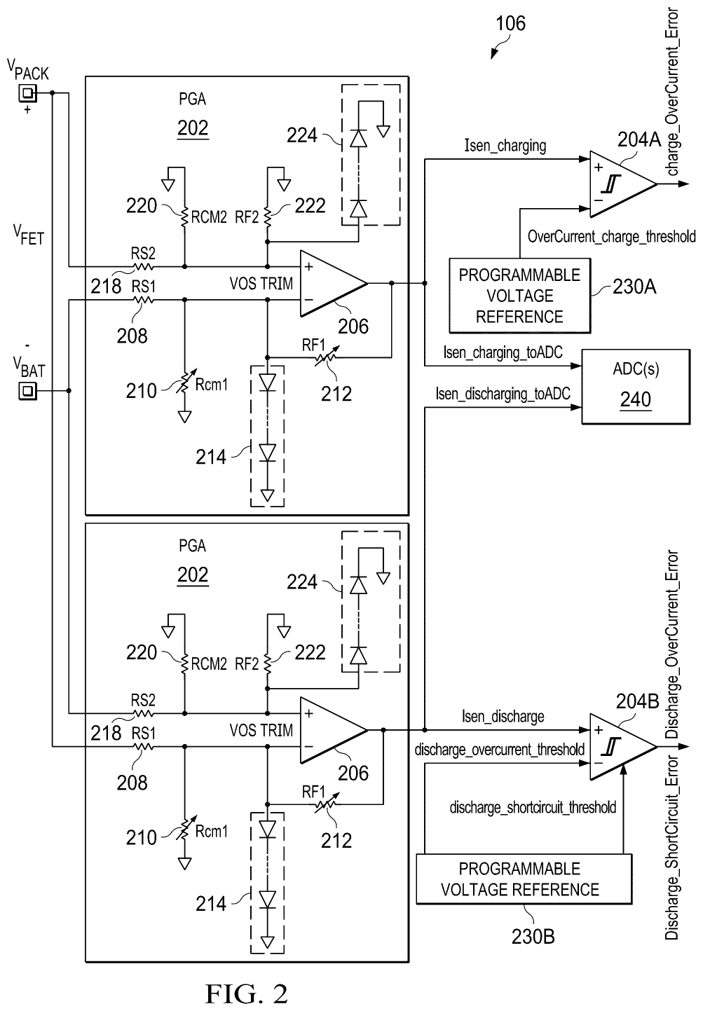

FIG. 2 illustrates selected components of a battery management system 106, in accordance with embodiments of the present disclosure. For purposes of clarity and exposition, FIG. 2 illustrates components of battery management system 106 for providing high-side cell protection to battery 102, but it is understood that battery management system 106 may include other components, such as those for charging battery 102 from power supply 104. In operation, battery management system 106 may measure a voltage V_{FET}=V_{PACK}−V_{BAT} across protection FET 108 in order to determine current driven by battery 102, thus alleviating a need for a high-side sense resistor often used in traditional approaches.

As shown in FIG. 2, battery management system 106 may include differential (or pseudo-differential) to single-ended programmable gain amplifiers (PGAs) 202 that drive their respective outputs to respective inputs of comparators 204 (e.g., comparators 204A and 204B). Each PGA 202 may include an operational amplifier 206, an input resistor 208 having resistance R_{S1} coupled between battery voltage V_{BAT} and the inverting input of operational amplifier 206, a variable common mode resistor 210 having resistance R_{CM1} coupled between the inverting input of operational amplifier 206 and ground (or a pre-determined level shifting voltage or supply voltage, a variable resistor 212 having resistance R_{F1} and coupled between the inverting input of operational amplifier 206 and the output of operational amplifier 206, a first high-voltage protection element 214 coupled between the inverting input of operational amplifier 206 and ground, an input resistor 218 having resistance R_{S2} coupled between pack voltage V_{PACK} and the non-inverting input of operational amplifier 206, a variable common mode resistor 220 having resistance R_{CM2} coupled between the non-inverting input of operational amplifier 206 and a supply voltage, a variable resistor 222 having resistance R_{F2} and coupled between the non-inverting input of operational amplifier 206 and the supply voltage, and a second high-voltage protection element 224 coupled between the non-inverting input of operational amplifier 206 and the supply voltage.

In alternative embodiments, a PGA 202 may float at the level of battery voltage V_{BAT}. In other words, such a PGA 202 and its associated comparator 204 may float with respect to battery voltage V_{BAT}, in which case the output of the associated comparator 204 may be level shifted to be referenced to ground voltage. In such embodiments, programmable voltage references 230 may also be floating with respect to battery voltage V_{BAT}.

First high-voltage protection element 214 and second high-protection element 224 may each be implemented with a plurality of series-coupled diodes or with FETs and may function to protect against high voltages that may be present on battery voltage V_{BAT} and pack voltage V_{PACK} that may damage battery management system 106.

The output of each PGA 202 may be processed by a respective comparator 204 in order to determine if a fault condition exists. Variable programmable references 230A and 230B may be respectively provided to comparators 204A and 204B. Comparator 204A may be configured to detect an overcurrent fault that may occur during charging of battery 102 while comparator 204B may be configured to detect an overcurrent fault that may occur during discharging of battery 102. Although the example of FIG. 2 depicts the use of two PGAs 202 and two comparators 204, those of skill in the art may recognize that fault detection may also be implemented using a single PGA 202 and single comparator 204. Offsets present in PGAs 202 and comparators 204 may be trimmed for increased accuracy.

As can be seen from FIG. 1, a resistance between battery voltage V_{BAT} and pack voltage V_{PACK} may include an on resistance of protection FET 108. Protection FET 108 may have different operating states depending on whether battery 102 is being charged or discharged. Battery management system 106 may fully enable protection FET 108 when battery 102 is in charge mode and discharge mode, and in these modes, battery management system 106 may monitor FET voltage V_{FET} to monitor the current flowing into or out of battery 102. The on resistance of protection FET 108 may vary 10% across a gate-to-source voltage Vos of protection FET 108 and may also vary 30% with temperature.

The variability of the on resistance of protection FET 108 may be estimated using low-side sense resistor 110 and one or more ADCs 240 of battery management system 106. ADCs 240 may monitor on FET, on circuit board, on-die and/or on-chip temperature sensors (not shown in the figures) to trigger re-estimation of the on resistance of protection FET 108 when needed. A gate limiter for protection FET 108 may be configured to minimize variation in gate-to-source voltage Vs. Gate-to-source voltage Vos may be monitored by one or more ADCs 240 to trigger a re-estimation of the on resistance or to add predetermined digital compensation to the programmable voltage references to compensate for the change in the on resistance for protection FET 108.

Battery management system 106 may also be configured to calculate a scale factor to be applied to one or more of programmable voltage references 230A and 230B. To illustrate, a current flowing through protection FET 108 equals the current flowing through low-side sense resistor 110. ADCs 240 may be periodically used to measure output of PGAs 202 to estimate resistance of protection FET 108. Thus, current I flowing through battery 102 may be sensed using low-side sense resistor 110 in accordance with:

$$I = \frac{Δ {V}_{LS}}{{R}_{LS}}$$

where V_{LS} is the voltage across low-side sense resistor 110 and R_{LS} is the resistance of low-side sense resistor 110. In turn, resistance R_{FET} of protection FET 108 may be estimated by:

$${R}_{FET} = \frac{Δ {V}_{FET}}{I} = \frac{Δ {V}_{FET} {R}_{LS}}{Δ {V}_{LS}}$$

A resistance scale factor S may then be calculated as the ratio of resistance R_{FET} of protection FET 108 to resistance R_{LS} of low-side sense resistor 110:

$$S = \frac{{R}_{FET}}{{R}_{LS}} = \frac{Δ {V}_{FET}}{Δ {V}_{LS}}$$

As mentioned above, scale factor S may be applied to one or more of programmable voltage references 230A and 230B to track the variation in resistance REET of protection FET 108. The accuracy of scale factor S may be dependent on the nominal on resistance value of protection FET 108 and resistance R_{LS} of low-side sense resistor 110. To desensitize from these uncertainties, battery management system 106 may perform a one-time factory calibration during manufacturing.

Such calibration may be performed after protection FET 108, low-side sense resistor 110, and an IC for battery management system 106 are mounted on a printed circuit board. Under such calibration, battery voltage V_{BAT} may be applied to the IC, battery management system 106 may be enabled to an “on resistance” calibration mode, and a predetermined load current may be applied between the node of pack voltage V_{PACK} and ground. Such predetermined load current may be sourced from battery 102 and pass through both protection FET 108 and low-side sense resistor 110. Battery management system 106 may self-calibrate by monitoring voltage FET voltage V_{FET} and low-side voltage V_{LS} and using ADCs 240 to return a scaling factor S and by writing the scaling factor and the temperature of battery management system 106 in a non-volatile memory.

Performance of this manufacturing calibration procedure may desensitize the design to absolute value variations of resistance R_{LS} and on resistance of protection FET 108 at room temperature. The accuracy of such calibration may be further improved by capturing temperature coefficients of resistance R_{LS} and saving such coefficients into non-volatile memory. Battery management system 106 may then, during operation, use such temperature coefficients to calibrate out variations of resistance R_{LS} with respect to ambient temperature.

As disclosed herein, embodiments of the present disclosure may involve a calibration scheme that provides the accuracy for determining the thresholds for activating or deactivating the protection FET(s) based on a particular type of detected fault condition. Two independent sources for measuring current may be utilized. One independent source is an analog-to-digital converter (ADC) that measures current across a protection FET. Another independent source is an ADC (maybe the same or another ADC) that measures across a low-side resistor. The calibration scheme may be performed one-time during manufacturing calibration or during power up of a battery management system, such as a battery management IC. A scale factor may be determined from the readings of the ADC(s) (e.g., to make an estimation of an on resistance of the protection FET accurately at room temperature). Different scale factors may be used depending on the operating mode of the protection FET(s). When a fault is detected, the protection FET(s) may be deactivated (i.e., the battery is not able to charge or discharge). Advantageously, a high-side precision resistor may not be needed in this protection scheme.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112 (f) unless the words “means for” or “step for” are explicitly used in the particular claim.

What is claimed is:

1. A system comprising:
a battery;
a protection field-effect transistor electrically coupled to a first terminal of the battery, such that when the protection field-effect transistor is deactivated, substantially zero electrical current flows to and from the battery; and
a battery management system electrically coupled to the protection field-effect transistor and configured to:
sense a first voltage across the protection field-effect transistor; and
control the protection field-effect transistor based on the first voltage.

2. The system of claim 1, wherein the battery management system is implemented as an integrated circuit.

3. The system of claim 1, wherein the battery management system is further configured to control the protection field-effect transistor based on a comparison of the first voltage to a reference voltage.

4. The system of claim 3, further comprising a sense resistor coupled to a second terminal of the battery, and wherein the battery management system is further configured to:
sense a second voltage across the sense resistor;
calculate a scaling factor equal to a ratio of a change in the first voltage to a change in the second voltage; and
apply the scaling factor to the reference voltage to compensate for variation in a resistance of the protection field-effect transistor.

5. The system of claim 3, further comprising a sense resistor coupled to a second terminal of the battery, and wherein the battery management system is further configured to, in response to a change in temperature associated with the system:
sense a second voltage across the sense resistor;
calculate a scaling factor equal to a ratio of a change in the first voltage to a change in the second voltage; and
apply the scaling factor to the reference voltage to compensate for variation in a resistance of the protection field-effect transistor.

6. The system of claim 1, further comprising a sense resistor coupled to a second terminal of the battery, and wherein the battery management system is further configured to:
sense a second voltage across the sense resistor;
calculate a scaling factor equal to a ratio of a change in the first voltage to a change in the second voltage; and
apply the scaling factor to compensate for variation in a resistance of the protection field-effect transistor.

7. The system of claim 1, further comprising a sense resistor coupled to a second terminal of the battery, and wherein the battery management system is further configured to, during manufacture of the system, calibrate for process variations of the protection field-effect transistor and the sense resistor.

8. The system of claim 7, wherein the battery management system is further configured to calibrate for process variations of the protection field-effect transistor and the sense resistor by:
causing a predetermined load current to flow through the battery, the protection field-effect transistor, and the sense resistor;
sensing the first voltage and the second voltage;
calculating a scaling factor equal to a ratio of a change in the first voltage to a change in the second voltage; and
storing, in a memory, the scaling factor and a temperature associated with the system at the time of calibration.

9. A method comprising:
sensing a first voltage across a protection field-effect transistor electrically coupled to a first terminal of a battery; and
controlling the protection field-effect transistor based on the first voltage, such that when the protection field-effect transistor is deactivated, substantially zero electrical current flows to and from the battery.

10. The method of claim 9, wherein the sensing and controlling steps are performed by a battery management system implemented as an integrated circuit.

11. The method of claim 9, further comprising controlling the protection field-effect transistor based on a comparison of the first voltage to a reference voltage.

12. The method of claim 11, further comprising:
sensing a second voltage across a sense resistor coupled to a second terminal of the battery;
calculating a scaling factor equal to a ratio of a change in the first voltage to a change in the second voltage; and
applying the scaling factor to the reference voltage to compensate for variation in a resistance of the protection field-effect transistor.

13. The method of claim 11, further comprising, in response to a change in temperature associated with a system comprising the protection field-effect transistor:
sensing a second voltage across a sense resistor coupled to a second terminal of the battery;
calculating a scaling factor equal to a ratio of a change in the first voltage to a change in the second voltage; and
applying the scaling factor to the reference voltage to compensate for variation in a resistance of the protection field-effect transistor.

14. The method of claim 9, further comprising:
sensing a second voltage across a sense resistor coupled to a second terminal of the battery;
calculating a scaling factor equal to a ratio of a change in the first voltage to a change in the second voltage; and
applying the scaling factor to compensate for variation in a resistance of the protection field-effect transistor.

15. The method of claim 9, further comprising, during manufacture of a system comprising the protection field-effect transistor, calibrating for process variations of the protection field-effect transistor and a sense resistor coupled to a second terminal of the battery.

16. The method of claim 15, further comprising calibrating for process variations of the protection field-effect transistor and the sense resistor by:
causing a predetermined load current to flow through the battery, the protection field-effect transistor, and the sense resistor;
sensing the first voltage and the second voltage;
calculating a scaling factor equal to a ratio of a change in the first voltage to a change in the second voltage; and
storing, in a memory, the scaling factor and a temperature associated with the system at the time of calibration.
